(19) United States
(12) Patent Application Publication
(10) Pub. No.: US 2025/0211608 A1
(43) Pub. Date: Jun. 26, 2025

(54) QUANTUM-SECURE EDGE COMMUNICATION

(71) Applicant: Dell Products L.P., Round Rock, TX (US)

(72) Inventors: Parminder Singh Sethi, Ludhiana (IN); Srinath Kappgal, Carrick-on-Suir (IE); Praveen Kumar, Noida (IN)

(21) Appl. No.: 18/393,961

(22) Filed: Dec. 22, 2023

(51) Int. Cl. H04L 9/40

(52) U.S. Cl. CPC H04L 63/1441; H04L 63/06

(57) ABSTRACT

Techniques for quantum-secure communications in an edge computing environment are disclosed. For example, a method comprises establishing a secure communication channel between a set of one or more devices in an edge computing environment, wherein the secure communication channel is configured to protect against one or more quantum computer-initiated cyberattacks.

### FIELD

The field relates generally to information processing systems, and more particularly to secure communications in such information processing systems.

### BACKGROUND

A distributed machine-to-machine computing network such as, for example, an Internet of Things (IoT) computing environment, can be part of an information processing system. The IoT computing environment typically comprises a plurality of smart devices connected via a communication network in which a large amount of data is transmitted to and from the smart devices.

Edge devices are examples of smart devices with computing power at or near the end-user. Edge computing is a strategy for computing on location where data is collected or used. This strategy allows the data to be processed at the edge of the computing environment rather than sending the data back to a centralized datacenter or cloud computing platform that can also be part of the information processing system.

Thus, edge computing takes place at or near the physical location of the user or source of the data. The edge devices serve as network entry and/or exit points, and are deployed to realize the benefit from enhanced local physical security. Since edge computing networks are responsible for connecting local area networks to external networks, they can be vulnerable to cyberattacks. However, conventional cryptographic methods are no match for the looming threat of powerful quantum computers that can compromise the integrity and the confidentiality of data transmitted in an edge computing environment.

### SUMMARY

Illustrative embodiments provide techniques for quantum-secure communications in an edge computing environment.

For example, in an illustrative embodiment, a method comprises establishing a secure communication channel between a set of one or more devices in an edge computing environment, wherein the secure communication channel is configured to protect against one or more quantum computer-initiated cyberattacks.

In some embodiments, establishing the secure communication channel may further comprise generating one or more quantum-secure random numbers, and using the one or more quantum-secure random numbers to generate and distribute one or more quantum-secure cryptographic keys to each of the set of one or more devices to enable the set of one or more devices to respectively encrypt data transmitted therefrom over the secure communication channel.

In some embodiments, establishing the secure communication channel may further comprise detecting one or more anomalies associated with the data encrypted and transmitted by the set of one or more devices, and rerouting at least a portion of the data for which the one or more anomalies are detected.

In some embodiments, establishing the secure communication channel may further comprise detecting tampering in the edge computing environment, and initiating one or more remedial actions in response to the tampering being detected.

In some embodiments, establishing the secure communication channel may further comprise causing erasure of the data transmitted by the set of one or more devices after successful transmission.

In some embodiments, establishing the secure communication channel may further comprise authenticating the set of one or more devices.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

### BRIEF DESCRIPTION OF THE DRAWINGS

FIG. 1 illustrates an edge computing environment with quantum-secure communication functionalities according to an illustrative embodiment.

FIG. 2 illustrates a quantum-secure communications methodology for an edge computing environment according to an illustrative embodiment.

FIGS. 3 and 4 illustrate examples of processing platforms that may be utilized to implement at least a portion of an edge computing environment with quantum-secure communication functionalities according to one or more illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed so as to encompass, for example, processing platforms comprising computing and/or storage systems, as well as other types of processing systems comprising various combinations of physical and/or virtual processing resources. An information processing system may therefore comprise, by way of example only, a plurality of edge devices enabled to communicate over an edge network as part of an edge computing environment.

As mentioned, it is realized that powerful quantum computers that are capable of breaking existing cryptographic algorithms are a significant threat to the integrity and confidentiality of data transmitted across a communication network. This threat is particularly evident in an edge computing environment wherein two edge devices communicate or otherwise transfer data therebetween.

Illustrative embodiments provide techniques for quantum-secure communication functionalities in an edge computing environment. More particularly, illustrative embodiments utilize one or more quantum-secure algorithms to generate cryptographic keys that are distributed to edge devices for encryption of data transmitted over a secure communication channel intended to be resistant to cyberattacks launched by quantum computers against the secure communication channel. Further, illustrative embodiments provide key renewal mechanisms and reconciliation techniques to thwart potential threats. Still further, illustrative embodiments authenticate edge devices to ensure only authorized devices access the secure communication channel, while quantum sensors continuously monitor the channel for any malicious activity and tamper detection techniques automatically take action to protect the data transmitted between the edge devices. For example, illustrative embodiments identify abnormal patterns that are indicative of real-time quantum computer-based attacks and dynamically reroute data ensuring data follows the most secure path. In addition, post-data erasure techniques are used to securely delete sensitive information after transmission eliminating any future quantum computing threats.

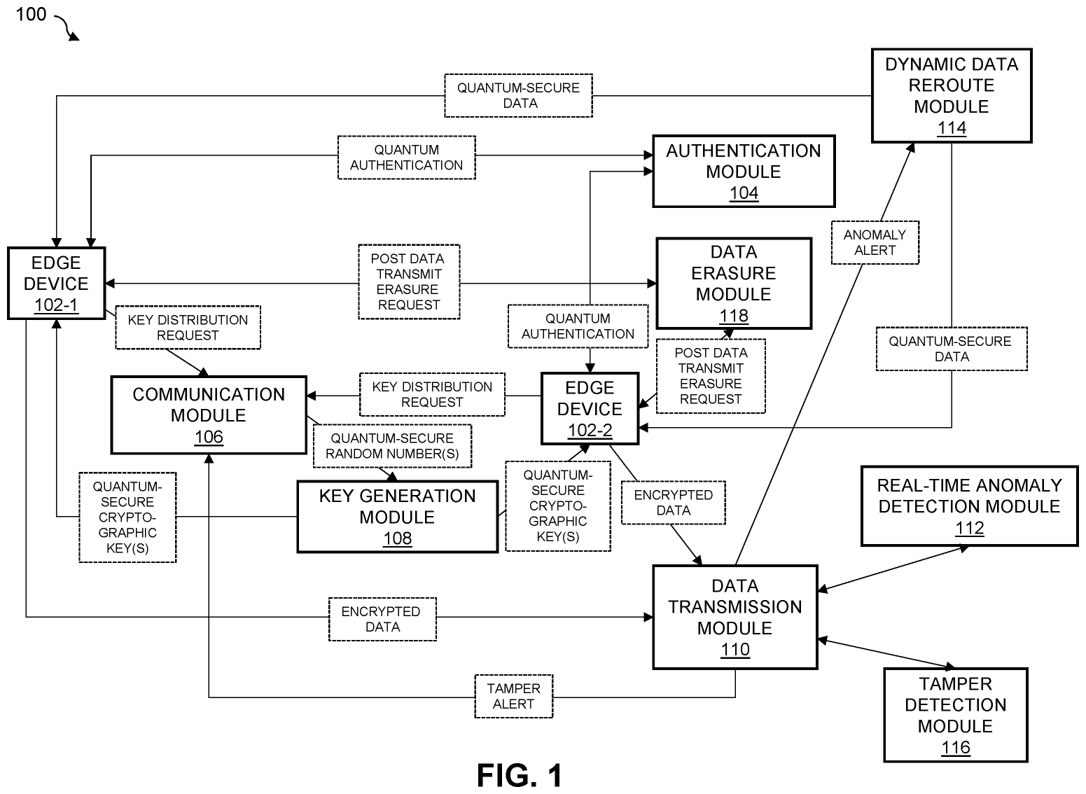

FIG. 1 illustrates an edge computing environment 100 with quantum-secure communication functionalities according to an illustrative embodiment. As shown in this illustrative embodiment, two edge devices 102-1 and 102-2 are configured to communicate over an edge network (not expressly shown). Integrated with the edge network are a plurality of modules, as shown, that enable quantum-secure communication functionalities for the edge devices. More particularly, the plurality of modules comprises an authentication module 104, a communication module 106, a key generation module 108, a data transmission module 110, a real-time anomaly detection module 112, a dynamic data reroute module 114, a tamper detection module 116, and a data erasure module 118.

In some illustrative embodiments, the plurality of modules are implemented on infrastructure of the edge network, while in other illustrative embodiments, one or more of the plurality of modules are implemented on infrastructure separate from but in communication with the edge network infrastructure.

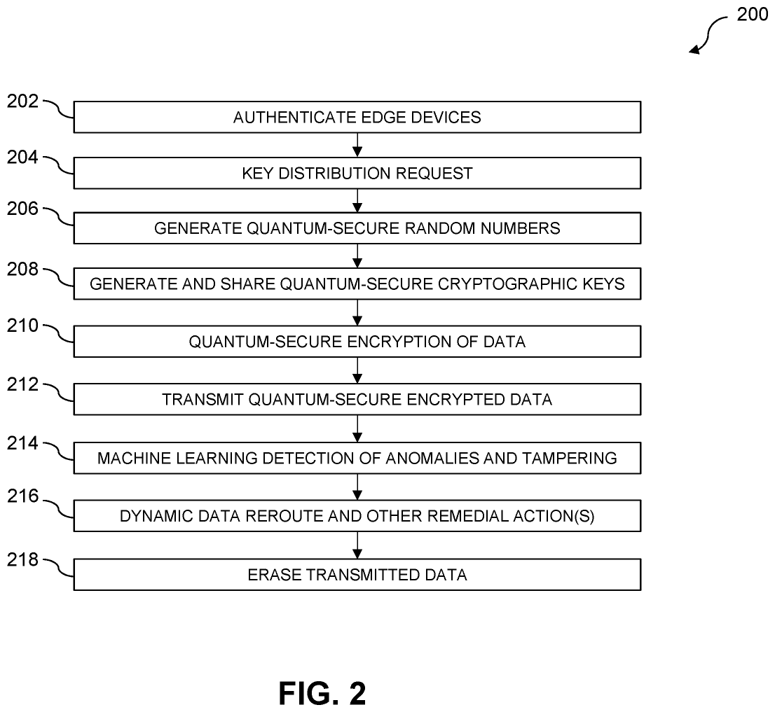

With reference to a quantum-secure communications methodology 200 illustrated in FIG. 2, prior to quantum-secure communication between edge devices 102-1 and 102-2 across the edge network, each of edge devices 102-1 and 102-2 are authenticated (step 202) by authentication module 104, in conjunction with the edge network, using one or more conventional authentication protocols, e.g., multi-factor credential exchange, etc. In some embodiments, authentication can be performed in conjunction with cryptographic key requests, e.g., authentication and key agreement protocols, etc. Once authenticated, each of edge devices 102-1 and 102-2 initiate quantum-secure key distribution by sending a request (step 204) to communication module 106.

In response to the request from each of edge devices 102-1 and 102-2, communication module 106 performs a quantum-secure random number generation process (step 206) to generate one or more quantum-secure random numbers. In some embodiments, communication module 106 implements a quantum random number generator (QRNG) using one or more commercially-available QRNG techniques such as, but not limited to, nuclear decay, shot noise, and/or quantum optics, etc. QRNG can generate random numbers that are considered to be true random numbers. However, communication module 106 can implement any technique that is designed to prevent a quantum computer from determining the random number (i.e., quantum-indeterministic, quantum-safe, or in general, as used herein, quantum-secure).

The one or more quantum-secure random numbers generated by communication module 106 are provided to key generation module 108 which generates and shares one or more quantum-secure cryptographic keys (step 208) with each of edge devices 102-1 and 102-2.

In some illustrative embodiments, key generation module 108 can implement quantum key distribution (QKD) which is a secure communication method that implements a cryptographic protocol involving components of quantum mechanics. It enables two parties, e.g., edge devices 102-1 and 102-2, to produce a shared random secret key known only to them, which then can be used to encrypt and decrypt data.

In some other illustrative embodiments, communication module 106, key generation module 108, and/or other ones of the plurality of modules mentioned above, may comprise commercially-available quantum simulation techniques whereby a classical (binary-based or non-quantum) computer executes one or more programs that simulate a quantum (qubit-based) computer.

The one or more quantum-secure cryptographic keys are then used by each of edge devices 102-1 and 102-2 to encrypt data (step 210) to be exchanged therebetween. Encrypted data transmitted (step 212) from each of edge devices 102-1 and 102-2 is received by data transmission module 110. Data transmission module 110 is operatively coupled to real-time anomaly detection module 112. In some embodiments, real-time anomaly detection module 112 is configured to use one or more commercially-available machine learning anomaly detection algorithms to detect, in real-time, any abnormal patterns in the encrypted data received from each of edge devices 102-1 and 102-2, and/or other anomalies in the edge network (part of step 214). Such machine learning anomaly detection algorithms may be configured to detect data anomalies caused by a quantum computer attempting to compromise (e.g., break, crack, decrypt, read, alter, etc.) the encrypted data.

In response to detection of an anomaly, data transmission module 110 notifies dynamic data reroute module 114. Dynamic data reroute module 114 is enabled to cause rerouting of the encrypted data originating from one or both of edge devices 102-1 and 102-2 (i.e., depending on which set of encrypted data is believed to be affected by the detected anomaly) through one or more alternate paths in the edge network than originally intended to be routed to avoid the anomaly (part of step 216).

It is to be appreciated that the term “a secure communication channel” as illustratively used herein refers to one or more paths through which edge device data is transmitted within the edge network (i.e., edge computing environment).

Further, as shown, data transmission module 110 is also operatively coupled to tamper detection module 116. In some embodiments, tamper detection module 116 employs one or more quantum sensors configured to detect any edge network tampering (e.g., listening, manipulation, intrusion, etc.) caused by a quantum computer (part of step 214). In response to tampering being detected, data transmission module 110 sends a tamper alert message to communication module 106 which can then take one or more remedial actions (part of step 216). For example, communication module 106 can generate new random numbers such that new cryptographic keys can be generated and used by edge devices 102-1 and 102-2 to encrypt and transmit data going forward.

Still further, as shown, data erasure module 118 is configured to cause erasure (step 218) of data transmitted by edge devices 102-1 and 102-2 in the edge network. This is particularly important when the transmitted data comprises sensitive data. Additionally or alternatively to erasing the transmitted data from the edge network, the transmitted data can also be erased at each of edge devices 102-1 and 102-2. Edge devices 102-1 and 102-2 or data erasure module 118 can initiate requests to erase the data.

It is to be appreciated that while FIG. 1 illustrates quantum-secure communication between two edge devices, it is to be appreciated that quantum-secure communication functionalities described herein can be applied to data that is transmitted by one of the two edge devices but destined for an edge device other than the other of the two edge devices. Further, quantum-secure communication functionalities described herein can be applied to more than two edge devices and, more generally, to any set of computing, storage, network devices or any other electronic devices capable of transmitting data in a communication network or any information processing system.

The particular processing operations and other system functionality described in conjunction with the diagrams described herein are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

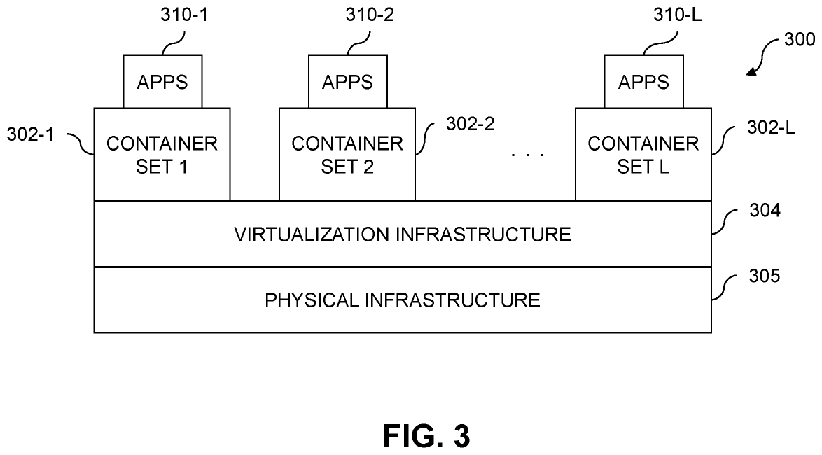

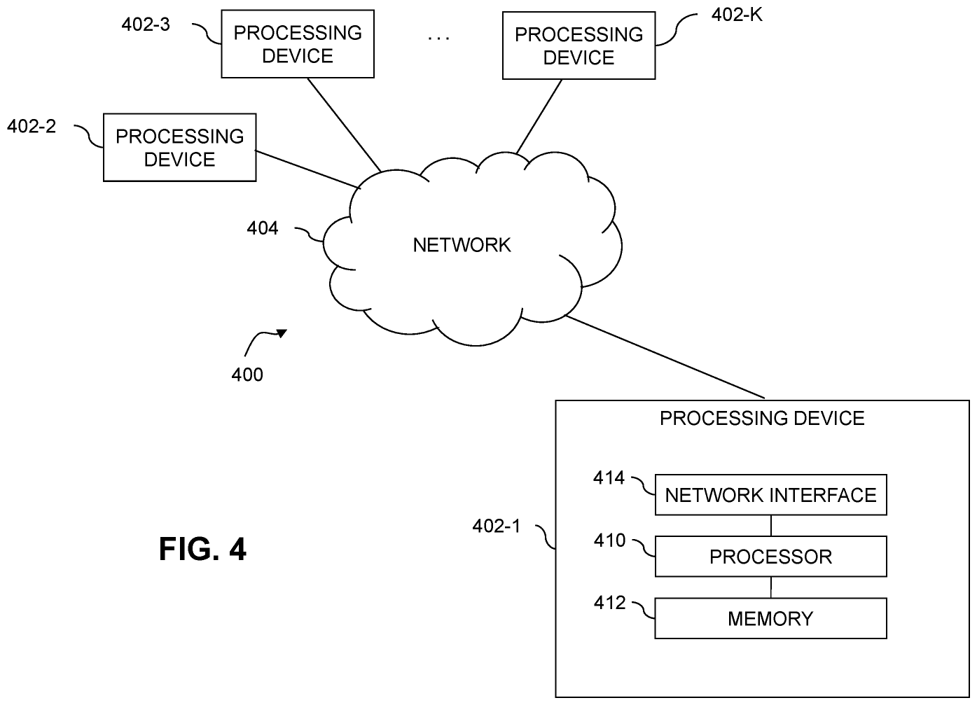

Illustrative embodiments of processing platforms utilized to implement quantum-secure communication functionalities will now be described in greater detail with reference to FIGS. 3 and 4. Although described in the context of systems/module/processes of FIGS. 1 and 2, these platforms may also be used to implement at least portions of other information processing systems in other embodiments. By way of example only, edge devices 102-1 and 102-2, and the plurality of modules comprising authentication module 104, communication module 106, key generation module 108, data transmission module 110, real-time anomaly detection module 112, dynamic data reroute module 114, tamper detection module 116, and data erasure module 118, may be implemented on one or more of the processing platforms illustrated in FIGS. 3 and 4, as well as any other suitable processing platform.

FIG. 3 shows an example processing platform comprising computing infrastructure 300. The computing infrastructure 300 comprises a combination of physical and virtual processing resources that may be utilized to implement at least a portion of environments and processes depicted in FIGS. 1 and 2. The computing infrastructure 300 comprises multiple container sets 302-1, 302-2, . . . 302-L implemented using virtualization infrastructure 304. The virtualization infrastructure 304 runs on physical infrastructure 305, and illustratively comprises one or more hypervisors and/or operating system level virtualization infrastructure.

The computing infrastructure 300 further comprises sets of applications 310-1, 310-2, . . . 310-L running on respective ones of the container sets 302-1, 302-2, . . . 302-L under the control of the virtualization infrastructure 304. The container sets 302 may comprise respective sets of one or more containers.

In some implementations of the FIG. 3 embodiment, the container sets 302 comprise respective containers implemented using virtualization infrastructure 304 that provides operating system level virtualization functionality, such as support for Kubernetes-managed containers.

As is apparent from the above, one or more of the processing modules or other components of environments and processes depicted in FIGS. 1 and 2 may each run on a computer, server, storage device or other processing platform element. A given such element may be viewed as an example of what is more generally referred to herein as a “processing device.” The computing infrastructure 300 shown in FIG. 3 may represent at least a portion of one processing platform. Another example of such a processing platform is processing platform 400 shown in FIG. 4.

The processing platform 400 in this embodiment comprises at least a portion of environments and processes depicted in FIGS. 1 and 2 and includes a plurality of processing devices, denoted 402-1, 402-2, 402-3, . . . 402-K, which communicate with one another over a network 404.

The network 404 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 402-1 in the processing platform 400 comprises a processor 410 coupled to a memory 412.

The processor 410 may comprise a microprocessor, a microcontroller, an application-specific integrated circuit (ASIC), a field-programmable gate array (FPGA) or other type of processing circuitry, as well as portions or combinations of such circuitry elements.

The memory 412 may comprise random access memory (RAM), read-only memory (ROM), flash memory or other types of memory, in any combination. The memory 412 and other memories disclosed herein should be viewed as illustrative examples of what are more generally referred to as “processor-readable storage media” storing executable program code of one or more software programs.

Articles of manufacture or computer program products comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 402-1 is network interface circuitry 414, which is used to interface the processing device with the network 404 and other system components, and may comprise conventional transceivers.

The other processing devices 402 of the processing platform 400 are assumed to be configured in a manner similar to that shown for processing device 402-1 in the figure.

Again, the particular processing platform 400 shown in the figure is presented by way of example only, and systems/modules/processes of FIGS. 1 and 2 may include additional or alternative processing platforms, as well as numerous distinct processing platforms in any combination, with each such platform comprising one or more computers, servers, storage devices or other processing devices.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality as disclosed herein are illustratively implemented in the form of software running on one or more processing devices.

As mentioned above, all or parts of the processing platforms of FIGS. 3 and/or 4, and/or any alternative processing platforms, may be utilized to implement an apparatus, a computer program product (an article of manufacture) and a method for providing a secure communication channel configured to protect against one or more quantum computer-initiated cyberattacks quantum-secure (e.g., quantum-secure communication).

For example, an apparatus may comprise at least one processing platform comprising at least one processor coupled to at least one memory, wherein the at least one processing platform, when executing program code, is configured to establish a secure communication channel between a set of one or more devices in an edge computing environment, wherein the secure communication channel is configured to protect against one or more quantum computer-initiated cyberattacks.

Further, to establish the secure communication channel, the at least one processing platform may further be configured to generate one or more quantum-secure random numbers, and use the one or more quantum-secure random numbers to generate and distribute one or more quantum-secure cryptographic keys to each of the set of one or more devices to enable the set of one or more devices to respectively encrypt data transmitted therefrom over the secure communication channel.

Still further, to establish the secure communication channel, the at least one processing platform may further be configured to detect one or more anomalies associated with the data encrypted and transmitted by the set of one or more devices, and reroute at least a portion of the data for which the one or more anomalies are detected. In some embodiments, the one or more anomalies may be detected via one or more machine learning algorithms.

In addition, to establish the secure communication channel, the at least one processing platform may further be configured to detect tampering in the edge computing environment, and initiate one or more remedial actions in response to the tampering being detected. In some embodiments, the one or more remedial actions may comprise causing the at least one processing platform to generate one or more updated quantum-secure random numbers and use the one or more updated quantum-secure random numbers to generate and distribute one or more updated quantum-secure cryptographic keys to each of the set of one or more devices to enable the set of one or more devices to respectively encrypt subsequent data transmitted therefrom.

Also, to establish the secure communication channel, the at least one processing platform is may further be configured to one or more of cause erasure of data transmitted by the set of one or more devices after successful transmission, and authenticate the set of one or more devices.

It should again be emphasized that the above-described embodiments are presented for purposes of illustration only. Many variations and other alternative embodiments may be used. For example, the disclosed techniques are applicable to a wide variety of other types of information processing systems, host devices, storage systems, container monitoring tools, container management or orchestration systems, container metrics, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, the at least one processing platform, when executing program code, is configured to:
establish a secure communication channel between a set of one or more devices in an edge computing environment, wherein the secure communication channel is configured to protect against one or more quantum computer-initiated cyberattacks.

2. The apparatus of claim 1, wherein, to establish the secure communication channel, the at least one processing platform is further configured to:
generate one or more quantum-secure random numbers; and
use the one or more quantum-secure random numbers to generate and distribute one or more quantum-secure cryptographic keys to each of the set of one or more devices to enable the set of one or more devices to respectively encrypt data transmitted therefrom over the secure communication channel.

3. The apparatus of claim 2, wherein, to establish the secure communication channel, the at least one processing platform is further configured to:
detect one or more anomalies associated with the data encrypted and transmitted by the set of one or more devices; and
reroute at least a portion of the data for which the one or more anomalies are detected.

4. The apparatus of claim 3, wherein the one or more anomalies are detected via one or more machine learning algorithms.

5. The apparatus of claim 2, wherein, to establish the secure communication channel, the at least one processing platform is further configured to:
detect tampering in the edge computing environment; and
initiate one or more remedial actions in response to the tampering being detected.

6. The apparatus of claim 5, wherein the one or more remedial actions comprise causing the at least one processing platform to generate one or more updated quantum-secure random numbers and use the one or more updated quantum-secure random numbers to generate and distribute one or more updated quantum-secure cryptographic keys to each of the set of one or more devices to enable the set of one or more devices to respectively encrypt subsequent data transmitted therefrom.

7. The apparatus of claim 1, wherein, to establish the secure communication channel, the at least one processing platform is further configured to cause erasure of data transmitted by the set of one or more devices after successful transmission.

8. The apparatus of claim 1, wherein, to establish the secure communication channel, the at least one processing platform is further configured to authenticate the set of one or more devices.

9. A computer program product comprising a non-transitory processor-readable storage medium having stored therein program code of one or more software programs, wherein the program code when executed by at least one processing platform causes the at least one processing platform to establish a secure communication channel between a set of one or more devices in an edge computing environment, wherein the secure communication channel is configured to protect against one or more quantum computer-initiated cyberattacks.

10. The computer program product of claim 9, wherein establishing the secure communication channel further comprises:
generating one or more quantum-secure random numbers; and
using the one or more quantum-secure random numbers to generate and distribute one or more quantum-secure cryptographic keys to each of the set of one or more devices to enable the set of one or more devices to respectively encrypt data transmitted therefrom over the secure communication channel.

11. The computer program product of claim 10, wherein establishing the secure communication channel further comprises:
detecting one or more anomalies associated with the data encrypted and transmitted by the set of one or more devices; and
rerouting at least a portion of the data for which the one or more anomalies are detected.

12. The computer program product of claim 11, wherein the one or more anomalies are detected via one or more machine learning algorithms.

13. The computer program product of claim 10, wherein establishing the secure communication channel further comprises:
detecting tampering in the edge computing environment; and
initiating one or more remedial actions in response to the tampering being detected.

14. The computer program product of claim 13, wherein the one or more remedial actions comprise causing the at least one processing platform to generate one or more updated quantum-secure random numbers and use the one or more updated quantum-secure random numbers to generate and distribute one or more updated quantum-secure cryptographic keys to each of the set of one or more devices to enable the set of one or more devices to respectively encrypt subsequent data transmitted therefrom.

15. The computer program product of claim 9, wherein establishing the secure communication channel further comprises causing erasure of data transmitted by the set of one or more devices after successful transmission.

16. The computer program product of claim 9, wherein establishing the secure communication channel further comprises authenticating the set of one or more devices.

17. A method comprising:
establishing a secure communication channel between a set of one or more devices in an edge computing environment, wherein the secure communication channel is configured to protect against one or more quantum computer-initiated cyberattacks, wherein establishing the secure communication channel further comprises:
generating one or more quantum-secure random numbers; and
using the one or more quantum-secure random numbers to generate and distribute one or more quantum-secure cryptographic keys to each of the set of one or more devices to enable the set of one or more devices to respectively encrypt data transmitted therefrom over the secure communication channel.

18. The method of claim 17, wherein establishing the secure communication channel further comprises:
detecting one or more anomalies associated with the data encrypted and transmitted by the set of one or more devices; and
rerouting at least a portion of the data for which the one or more anomalies are detected.

19. The method of claim 18, wherein establishing the secure communication channel further comprises:
detecting tampering in the edge computing environment; and
initiating one or more remedial actions in response to the tampering being detected.

20. The method of claim 17, wherein establishing the secure communication channel further comprises at least one of:
causing erasure of the data transmitted by the set of one or more devices after successful transmission; and
authenticating the set of one or more devices.
